(19) United States
(12) Patent Application Publication
(10) Pub. No.: US 2013/0036292 A1
(43) Pub. Date: Feb. 7, 2013

(54) MEMORY CONFIGURATION APPARATUS FOR SUPPORTING ARBITRARY MEMORY SET AND METHOD THEREOF

(71) Applicant: Yongjoon Lee, Suwon-si (KR)

(72) Inventor: Yongjoon Lee, Suwon-si (KR)

(73) Assignee: SAMSUNG ELECTRONICS CO. LTD., Suwon-si (KR)

(21) Appl. No.: 13/564,133

(22) Filed: Aug. 1, 2012

(30) Foreign Application Priority Data
Aug. 1, 2011 (KR) 10-2011-0076705

(51) Int. Cl. G06F 12/00

(52) U.S. Cl. 711/216; 711/E12.001

(57) ABSTRACT

An apparatus and a method for supporting a memory set of an arbitrary number are provided. The apparatus includes a storage, a memory manager, and a controller. The storage is configured with the memory set of the arbitrary number. The memory manager indexes the memory set of the arbitrary number based on a Hash function and an index. The controller controls the memory manager.

### PRIORITY

This application claims the benefit under 35 U.S.C. §119(a) of a Korean patent application filed in the Korean Intellectual Property Office on Aug. 1, 2011 and assigned Serial No. 10-2011-0076705, the entire disclosure of which is hereby incorporated by reference.

### BACKGROUND OF THE INVENTION

1. Field of the Invention

The present invention relates to a system that uses a memory. More particularly, the present invention relates to an apparatus and a method for supporting a memory set of an arbitrary number in an electronic device.

2. Description of the Related Art

Generally, a system uses a memory set of power of 2 when configuring the memory set. Therefore, the number of memory sets becomes 1→2→4→8→16→ . . . 2ⁿ.

Other systems use a memory set in a sequential manner. This technology accesses a memory as many as the number of memories. For example, in the case where 100 memory cells exist, all memory cells need to be accessed in order to determine a memory cell in which necessary content is stored. In this case, since there is a possibility that the necessary content may be found initially, on average, the content may be found when 50% of the memory cells are accessed.

Since this method is inefficient compared to a method of accessing the memory using power of 2, performance may deteriorate significantly when accessing an upper level memory using this method.

The above methods also cannot realize various types of memory sets. Since the index method of the related art for a memory set can use only power (or sequential numbers) of 2 to access a memory, these methods cannot be used for a memory set of an arbitrary number.

For example, a memory set of 1024 can be used and an upper level memory that uses a memory set of 2048 can be used, but an upper level memory set having a memory set of 1535 cannot be used and a memory set of 2048 should be used to use a memory set of 1586.

### SUMMARY OF THE INVENTION

Aspects of the present invention are to address at least the above-mentioned problems and/or disadvantages and to provide at least the advantages described below. Accordingly, an aspect of the present invention is to provide a memory configuration apparatus for supporting an arbitrary memory set and a method thereof.

Another aspect of the present invention is to provide a memory configuration apparatus for supporting a memory set of an arbitrary number, not a memory set of power of 2.

In accordance with an aspect of the present invention, an apparatus for supporting a memory set of an arbitrary number is provided. The apparatus includes a storage configured with the memory set of the arbitrary number, a memory manager for indexing the memory set of the arbitrary number based on a Hash function and an index, and a controller for controlling the memory manager.

In accordance with another aspect of the present invention, a method for supporting a memory set of an arbitrary number is provided. The method includes determining an arbitrary number to be used as the number of the memory set, determining a constant corresponding to the determined number of the memory set, determining an index and a Hash function, and indexing a memory based on the determined index and the Hash function.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a memory index process using a Hash function according to an exemplary embodiment of the present invention;

FIG. 2 is a first view illustrating a memory index process using a Hash function in the case where k=4, m1=2, and m2=1 according to an exemplary embodiment of the present invention;

FIG. 3 is a second view illustrating a memory index process using a Hash function in the case where k=4, m1=2, and m2=1 according to an exemplary embodiment of the present invention;

FIG. 4 is a flowchart illustrating a process for indexing a memory according to an exemplary embodiment of the present invention; and

FIGS. 5A and 5B are block diagrams illustrating a system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a memory configuration apparatus for supporting a memory set of an arbitrary number using a Hash function in a system that uses a memory, and a method thereof. An apparatus and a method is described below for supporting a memory set of an arbitrary number using a Hash function in use when a microprocessor that is currently used generally accesses content of a memory.

In the case where a memory index method divides and accesses a memory for each level, a lower memory level may not store data depending on cases compared to an upper memory level. Since power of 2 is used as an index for memory access, a lower level memory deviating from a memory access address used by the system is not accessed. For this reason, a memory region that is not used exists and performance deterioration may occur during a memory access.

To remove a memory region that is not used, exemplary embodiments of the present invention provide an apparatus and a method for using a Hash function for a memory access used when a memory is accessed, that is usable even when the index is not power of 2 when the memory is indexed.

Exemplary embodiments of the present invention use a memory set of a general number for its object, and adds an additional address bit to generate and use a new Hash function when indexing a memory in order to make an access to a memory of a general number possible.

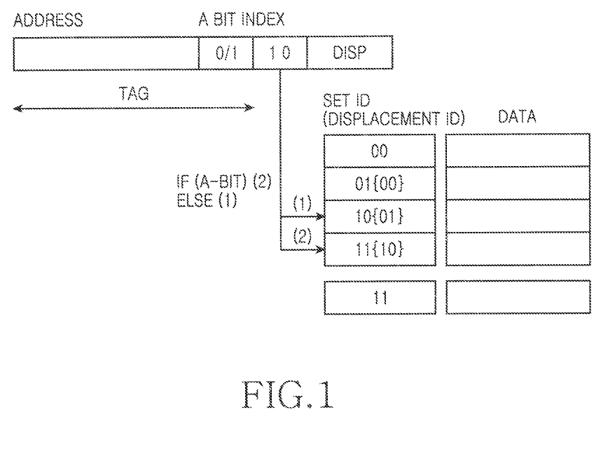

FIG. 1 is a view illustrating a memory index process using a Hash function according to an exemplary embodiment of the present invention.

Referring to FIG. 1, a case where k=2 is illustrated. The size of a memory set and a Hash function are given by Equation (1).

A size of a memory set=2^{k}+2^{(k-1)}−1

New_Hash(Address)=num(A)+index,A=A[k−2:0] (I)

where k is a value given as a natural number, and an index is a binary bit of a predetermined number and is determined by the size of a memory set.

In FIG. 1, Disp represents Displacement.

When the size of a memory set is calculated using Equation (1), the size of the memory set becomes 2²+(2¹−1), that is, 5. A Hash function New_Hash (address)=index+(A[1:0]). Accordingly, the size of A is 1. An A bit is denoted by an access bit.

In FIG. 1, the size of a memory set in use becomes 5, and the size of an index bit is set to 2 (a case where 2²=4 is possible) in order to support a memory set size 5. When the A bit is 0, a path of (1) is used. When the A bit is not 0, a path of (2) is used. Therefore, when the A bit is 0, 1st, 2nd, 3rd, and 4-th memories can be indexed. When the A bit is 1, 2nd, 3rd, 4-th, and 5-th memories can be indexed, so that a memory set of 5 can be indexed even when a memory set is not a memory set of power of 2.

In the drawings, a set ID represents a memory indexed according to an index bit when the A bit is 0. A displacement ID represents a memory indexed according to an index bit when the A bit is not 0.

An index method for a memory set of an arbitrary number according to an exemplary embodiment of the present invention is described below.

First, the size of a memory set is calculated using Equation 2 below. Alternatively, the size of a necessary memory set may be determined first, and a necessary constant value may be determined based on the determined size of the necessary memory set.

A size of a memory set=2^{k}+(2^{m1}−1)+(2^{m2}−1)+ . . . +(2^{mn}−1) (2)

where k, m1, m2, . . . , mn are arbitrary constants, and m1>m2> . . . >nm and are determined depending on the size of the memory set.

A Hash function used when a memory is indexed is given by Equation below.

$$New\_Hash ( Address ) = index + {\sum }_{i = 1}^{1 = n } hash ( i ) \qquad ( 3 )$$

where hash(i)=num (A[mi−1: m(i−1)-2]) and hash(1)=num(A[m1−1: 0]). The size of A=sum(m1+m2+ . . . +nm), and a unit is bit.

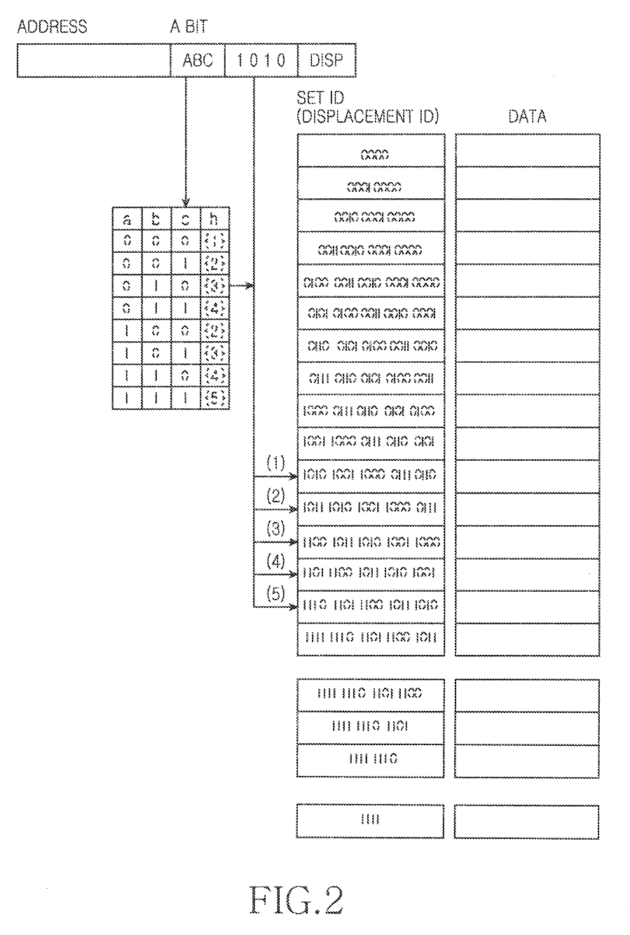

FIG. 2 is a first view illustrating a memory index process using a Hash function in the case where k=4, m1=2, and m2=1 according to an exemplary embodiment of the present invention.

Referring to FIG. 2, when Equation (3) is used, the size of A becomes sum(m1+m2)=3. In FIG. 2, the size of a memory set is 20, and to access 20 memories, 3 bits are used for A.

When Equation (3) is applied, New_Hash(1)=num(A[2-1:0])=num(A[1:0]), and New_Hash(2)=num(A[1-1:2-2])=num(A[0:0]). Accordingly, New_Hash(Address)=index+num(A[1:0])+num(A[0:0]). Since num(A[1:0])+num(A[0:0])=3 bits, 3 bits are used for an A bit and this is equal to A in size.

How 3 bits of A are mapped to (h), 1, 2, 3, 4 or 2, 3, 4, 5 according to exemplary embodiments of the present invention is described below.

A principle where 3 bits of A are mapped to (h) is to add a 3-bit value of A to an index. However, during addition, all of 3 bits are not used: 0-7 (a number expressible in terms of 3 bits) is not used but 2 bits and 1 bit are identified and mapped.

In the drawings, an index is 1010 (10 in terms of a decimal number). When an A bit is 000, a memory corresponding to an arrow (1) of the drawing is indexed. 1010 by the index, 0 by the first two bits, and 0 by the last one bit are added, so that 1010 becomes a result value of New_Hash(Address) and represents indexing a 11-th memory.

When A is 001 (1 in terms of a decimal number), 00 by the first two bits is added to the index 1010 and when the next 1 is used, 1010+1 is obtained, so that a 12-th memory is indexed.

When A is 111, a value 11 (3 in terms of a decimal number) of the first two bits is added to 1010 and a value of the last one bit is added, so that 1010+11+1 is obtained and a 15-th memory is indexed.

This shows that in case of 1010, five indexes for accessing a memory depending on an h value are generated even for the same index. One index overlaps an existing index.

In the case where an index bit is configured with 4 bits as in the drawing, 16 indexes for accessing a memory may be generated. When the above-described A bit of 3 bits according to exemplary embodiments of the present invention is utilized additionally, as described above, 4 indexes for accessing a memory are generated additionally.

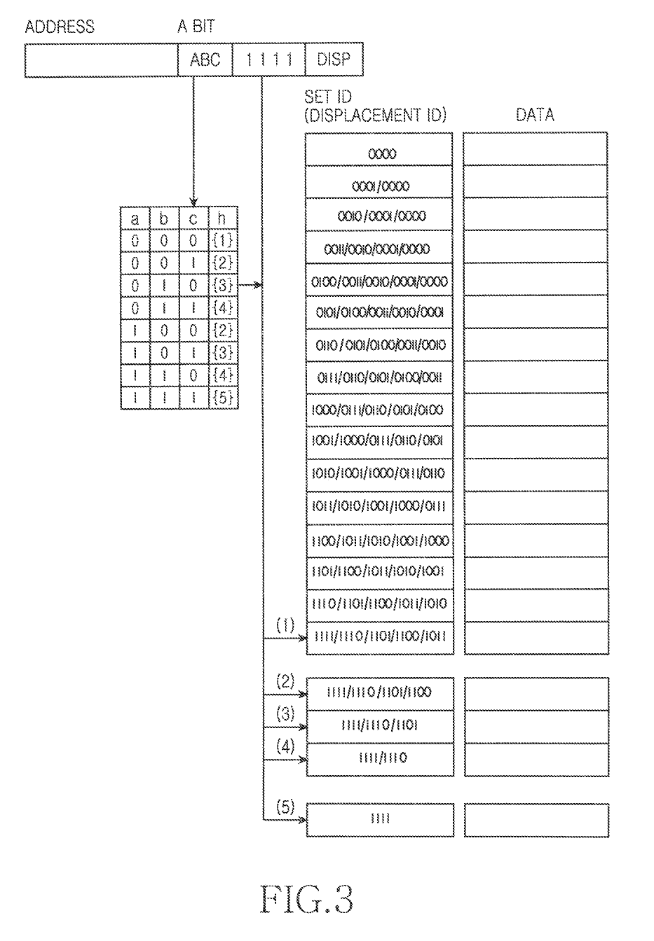

FIG. 3 is a second view illustrating a memory index process using a Hash function in the case where k=4, m1=2, and m2=1 according to an exemplary embodiment of the present invention.

Referring to FIG. 3, a case where an index bit in FIG. 2 is 1111 is illustrated. In the case where the index bit is 1111, as described above, five indexes are generated depending on the A bit. When a wrapping method is used with respect to a memory set of 2n, the size of an entire memory set may be designed in accordance with the number of 2n.

In this case, a 17-th index may use a first memory, an 18-th index may use a second memory, and a 19-th index may use a third memory. As a result, a memory set of a better performance may be realized while a balanced memory cell is configured.

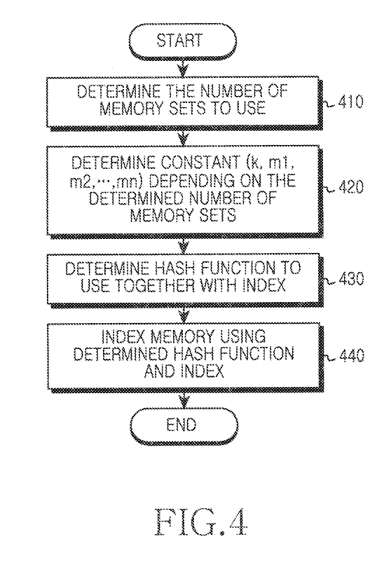

FIG. 4 is a flowchart illustrating a process for indexing a memory according to an exemplary embodiment of the present invention.

Referring to FIG. 4, the number of memory sets to use is determined in step 410. The number of memory sets need not be limited to power of 2.

A constant depending on the determined number of memory sets is determined in step 420. The constant is for determining a Hash function of the present invention, and may be k, m1, m2, . . . , mn, the number of index bits, etc., as described above. The constant is determined based on Equation (2).

A Flash function to use is determined based on the determined constant in step 430. The Hash function is determined based on the constant and determined based on Equation (3).

Memory indexing is performed using the determined Hash function and the index in step 440.

The method described above in relation with FIG. 4 under of the present invention may be provided as one or more instructions in one or more software modules, or computer programs stored in an apparatus.

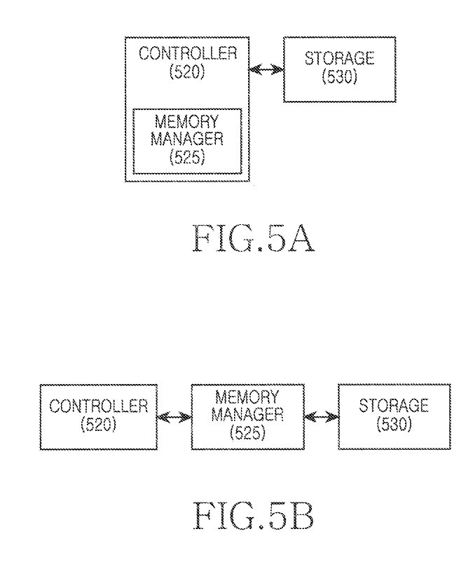

FIGS. 5A-5B are block diagrams illustrating an apparatus for performing memory indexing using a Hash function according to an exemplary embodiment of the present invention.

Referring to FIGS. 5A-5B, the apparatus includes a controller 520, a storage 530, and a memory manager 525. FIG. 5A illustrates a case where the memory manager 525 is included in the controller 520, and FIG. 5B illustrates a case where the memory manager 525 is located outside the controller 520. The memory manager 525 may be a memory controller for accessing a memory.

The controller 520 controls an overall operation of the apparatus, and more particularly, controls the memory manager 525.

The storage 530 stores a program for controlling an overall operation of the apparatus and temporary data occurring during execution of a program. The storage 520 may be a memory set as described herein.

The memory manager 525 indexes and accesses a memory using a Hash function and an index of the present invention when accessing the memory.

As in the case of FIG. 1, when the size of a necessary memory set is 5, an index bit is set to 2 bits and an A bit is set to 1 bit.

The memory manager 525 uses a path of (1) when the A bit is 0 and uses a path of (2) when the A bit is not 0.

Accordingly, the memory manager 525 can index 1st, 2nd, 3rd, and 4-th memories when the A bit is 0, and index 2nd, 3rd, 4-th, and 5-th memories when the A bit is 1, so that the memory manager 525 can index a memory set of 5 even when the memory set is not a memory set of power of 2.

In the case of FIG. 2 or FIG. 3, where the size of a necessary memory set is 20, in order to index these memories, an index bit is determined as 4 bits and the constants k, m1, m2, etc. are determined.

When an index is 1010 (10 in terms of a decimal number) and an A bit is 000, the memory manager 525 indexes a memory corresponding to an arrow (1) of the drawings. 1010 by the index, 0 by the first two bits, and 0 by the last one bit are added, so that 1010 becomes a result value of New_Hash (Address), and the memory manager 525 indexes an 11-th memory.

When A is 001 (1 in terms of a decimal number), 00 by the first two bits is added to the index 1010 and the next 1 is used, so that 1010+1 is obtained and the memory manager 525 indexes a 12-th memory.

When A is 111, a value 11 (3 in terms of a decimal number) of the first two bits and a value of the last one bit are added to 1010, so that 1010+11+1 is obtained and the memory manager 525 indexes a 15-th memory.

When a value of an index bit is 1111, as in the case of FIG. 3, the memory manager 525 indexes a 16˜20-th memory depending on a value of A.

According to exemplary embodiments of the present invention, an access to a memory set of an arbitrary number, not just a memory set of power of 2 is possible, and a cache miss rate reduces, so that a memory performance improves. Since excess memory is not used, power consumption and excessive memory use may be prevented.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for supporting a memory set of an arbitrary number, the apparatus comprising:
a storage configured with the memory set of the arbitrary number;
a memory manager for indexing the memory set of the arbitrary number based on a Hash function and an index; and
a controller for controlling the memory manager.

2. The apparatus of claim 1, wherein when the arbitrary number is 5, an index bit is determined to be 2 bits and an access bit is determined to be 1 bit.

3. The apparatus of claim 2, wherein when a value of the access bit has a first value, the memory manager indexes a 0-th memory to a 4-th memory.

4. The apparatus of claim 2, wherein when a value of the access bit has a second value, the memory manager indexes a 1st memory to a 5-th memory.

5. The apparatus of claim 1, wherein when the arbitrary number is 20, a constant value based on a size of the memory set is determined based on the equation below and an index bit is 4 bits:
a size of the memory set=2^{k}+(2^{m1}−1)+(2^{m2}−1)+ . . . +(2^{mn}−1),
where k, m1, m2, . . . , mn are arbitrary constants, m1>m2> . . . >nm and are determined based on the size of the memory set.

6. The apparatus of claim 5, wherein a Hash function based on the size of the memory set is determined based on the equation below:
$$New\_Hash ( Address ) = index + {\sum }_{i = 1}^{1 = n } hash ( i ) ,$$
where hash(i)=num (A[mi−1: m(i−1)−2]) and hash(1)=num(A[m1−1: 0]), and m1, m2, . . . , mn are arbitrary constants, m1>m2> . . . >nm and are determined based on the size of the memory set.

7. The apparatus of claim 5, wherein a size of an access bit is determined based on the equation below:
the size of the access bit=sum(m1+m2+ . . . +nm),
where m1, m2, . . . , mn are arbitrary constants, m1>m2> . . . >nm and are determined based on the size of the memory set.

8. The apparatus of claim 5, wherein the memory manager indexes a 1st to 16-th memory set to a 5-th to 20-th memory set based on a value of an access bit when indexing a memory.

9. The apparatus of claim 1, wherein a constant value based on a size of the memory set is determined based on the equation below:
a size of the memory set=2^{k}+(2^{m1}−1)+(2^{m2}−1)+ . . . +(2^{mn}−1),
where k, m1, m2, . . . , mn are arbitrary constants, m1>m2> . . . >nm and are determined based on the size of the memory set.

10. A method for supporting a memory set of an arbitrary number, the method comprising:
determining an arbitrary number to be used as the number of the memory set;
determining a constant corresponding to the determined number of the memory set;
determining an index and a Hash function; and
indexing a memory based on the determined index and the Flash function.

11. The method of claim 10, wherein when the arbitrary number is 5, an index bit is determined to be 2 bits and an access bit is determined to be 1 bit.

12. The method of claim 11, further comprising, when a value of the access bit has a first value, indexing a 0-th memory to a 4-th memory.

13. The method of claim 11, further comprising, when a value of the access bit has a second value, indexing a 1st memory to a 5-th memory.

14. The method of claim 10, wherein when the arbitrary number is 20, a constant value based on a size of the memory set is determined based on the equation below and an index bit is 4 bits:
a size of the memory set=2^{k}+(2^{m1}−1)+(2^{m2}−1)+ . . . +(2^{mn}−1),
where k, m1, m2, . . . , mn are arbitrary constants, m1>m2> . . . >nm and are determined based on the size of the memory set.

15. The method of claim 14, wherein a Hash function based on the size of the memory set is determined based on the equation below:
$$New\_Hash ( Address ) = index + {\sum }_{i = 1}^{1 = n } hash ( i ) ,$$
where hash(i)=num (A[mi−1: m(i−1)−2]) and hash(1)=num(A[m1−1: 0]), and m1, m2, . . . , mn are arbitrary constants, m1>m2> . . . >nm and are determined based on the size of the memory set.

16. The method of claim 14, wherein a size of an access bit is determined based on the equation below:
the size of the access bit=sum(m1+m2+ . . . +nm),
where m1, m2, . . . , nm are arbitrary constants, m1>m2> . . . >nm and are determined based on the size of the memory set.

17. The method of claim 14, further comprising indexing a 1st to 16-th memory set to a 5-th to 20-th memory set based on a value of an access bit when indexing a memory.

18. The method of claim 10, wherein a constant value based on a size of the memory set is determined based on the equation below:
a size of the memory set=2^{k}+(2^{m1}−1)+(2^{m2}−1)+ . . . +(2^{mn}−1),
where k, m1, m2, . . . , mn are arbitrary constants, m1>m2> . . . >nm and are determined based on the size of the memory set.
